(19) United States
(12) Patent Application Publication
(10) Pub. No.: US 2011/0309052 A1
(43) Pub. Date: Dec. 22, 2011

(54) MOVING SEAL WITH ARC CREEPAGE SURFACE FOR AN AIR CIRCUIT BREAKER

(75) Inventors: Brian John SCHALTENBRAND, Pittsburgh, PA (US); Mark Anthony JANUSEK, Pittsburgh, PA (US); Robert William MUELLER, Aliquippa, PA (US); James Michael SMELTZER, Salem, OH (US); William Michael RANDAL, Pittsburgh, PA (US)

(73) Assignee: EATON CORPORATION, Cleveland, OH (US)

(21) Appl. No.: 12/816,431

(22) Filed: Jun. 16, 2010

(51) Int. Cl. H01H 33/02

(52) U.S. Cl. 218/156

(57) ABSTRACT

A moving seal for an air circuit breaker provides an arc creepage surface that is positioned between a pair of separable contact assemblies when the moving seal is fit into an inlet of the arc chamber. The arc creepage surface has a surface contour that increases a length of an arc travel path between the separable contact assemblies, relative to a straight line distance between of separable contact assemblies.

### BACKGROUND

Electrical switching apparatus for power distribution systems include devices such as circuit breakers, network protectors, transfer switches and disconnect switches. A common type of circuit breaker is the air circuit breaker, which uses a flow of gas to extinguish the arc caused by separation of the contacts. The flow of gas may be provided by a source of compressed gas or by air exiting a sealed arc chamber that is pressurized when the contacts separate. The pressurization of the arc chamber may be accomplished by a moving seal that acts in cooperation with a contact carriage that carries the moveable contact away from the stationary contact. The moving seal moves into the arc chamber when the contacts separate, displacing air in the arc chamber. The air flows out of the arc chamber through an arc chute and extinguishes the arc. The moving seal is typically positioned near the stationary contact so that it can properly extinguish the arc. However, this close proximity may allow the arc to creep up the moving seal and short to the contact carriage, causing a short circuit condition.

### SUMMARY

A moving seal for an air circuit breaker is provided that includes a sealing portion having an arc creepage surface that is positioned between first and second circuit breaker contacts when the sealing portion is fit into an inlet of an arc chamber enclosing the first and second circuit breaker contacts. The arc creepage surface has a surface contour that increases the length of an arc travel path between the second circuit breaker contact and a contact carriage that carries the first circuit breaker contact, relative to a straight line distance between the second circuit breaker contact and the contact carriage. The arc creepage surface may have a substantially concave surface contour that includes a single concave groove or a plurality of parallel concave grooves.

In some example embodiments, the moving seal also includes an actuation portion configured to co-act with the contact carriage, where the contact carriage is operable to separate the first and second circuit breaker contacts. In these example embodiments, the arc chamber is substantially closed and the inlet is formed between the first and second circuit breaker contacts when the contact carriage carries the first circuit breaker contact away from the second circuit breaker contact. The sealing portion of the moving seal is configured to fit within the inlet open to seal the inlet and define a portion of the arc chamber. The actuation portion is operable to selectively position the sealing portion in the inlet when the contact carriage carries the first circuit breaker contact away from the second circuit breaker contact.

In another embodiment, an air circuit breaker is provided that includes a substantially closed arc chamber enclosing a pair of separable contact assemblies. The arc chamber includes an inlet that is formed between the pair of separable contact assemblies when the separable contact assemblies are separated. The air circuit breaker includes a moving seal configured to be fit within the inlet to close the inlet and define a portion of the arc chamber. The moving seal includes an arc creepage surface that is positioned between the pair of separable contact assemblies when the moving seal is fit into the inlet. The arc creepage surface has a surface contour that increases the length of an arc travel path between the pair of separable contact assemblies, relative to a straight line distance between the pair of separable contact assemblies. The arc creepage surface may have a substantially concave surface contour that includes a single concave groove or a plurality of parallel concave grooves.

### BRIEF DESCRIPTION OF THE DRAWINGS

The accompanying drawings, which are incorporated in and constitute a part of the specification, illustrate various example systems, methods, and other embodiments of various aspects of the invention. One of ordinary skill in the art will appreciate that in some embodiments one element may be designed as multiple elements, multiple elements may be designed as one element, an element shown as an internal component of another element may be implemented as an external component and vice versa, and so on. Furthermore, elements may not be drawn to scale.

FIG. 1 illustrates a prior art three pole air circuit breaker with a moving seal.

FIG. 1A is a perspective view of the moving seal in the air circuit breaker shown in FIG. 1.

FIG. 2 is a perspective view of a single circuit breaker pole that includes an example embodiment of a moving seal with an arc creepage surface.

FIG. 2A is a perspective view of the moving seal with arc creepage surface in the pole shown in FIG. 2.

FIG. 3 is a front view of a three pole air circuit breaker that includes the pole shown in FIG. 2 and that indicates a cross section to be shown in FIGS. 4-6.

FIG. 4 is a cross section of the air circuit breaker taken along 4-4 as indicated in FIG. 3 with a pole assembly in a closed or conducting position.

FIG. 5 is a cross section of the air circuit breaker taken along 4-4 as indicated in FIG. 3 with a pole assembly in an intermediate contact separation position.

FIG. 6 is a cross section of the air circuit breaker taken along 4-4 as indicated in FIG. 3 with a pole assembly in an open or non-conducting position.

FIG. 7 is a perspective view of another example embodiment of a moving seal that includes an arc creepage surface.

### DETAILED DESCRIPTION

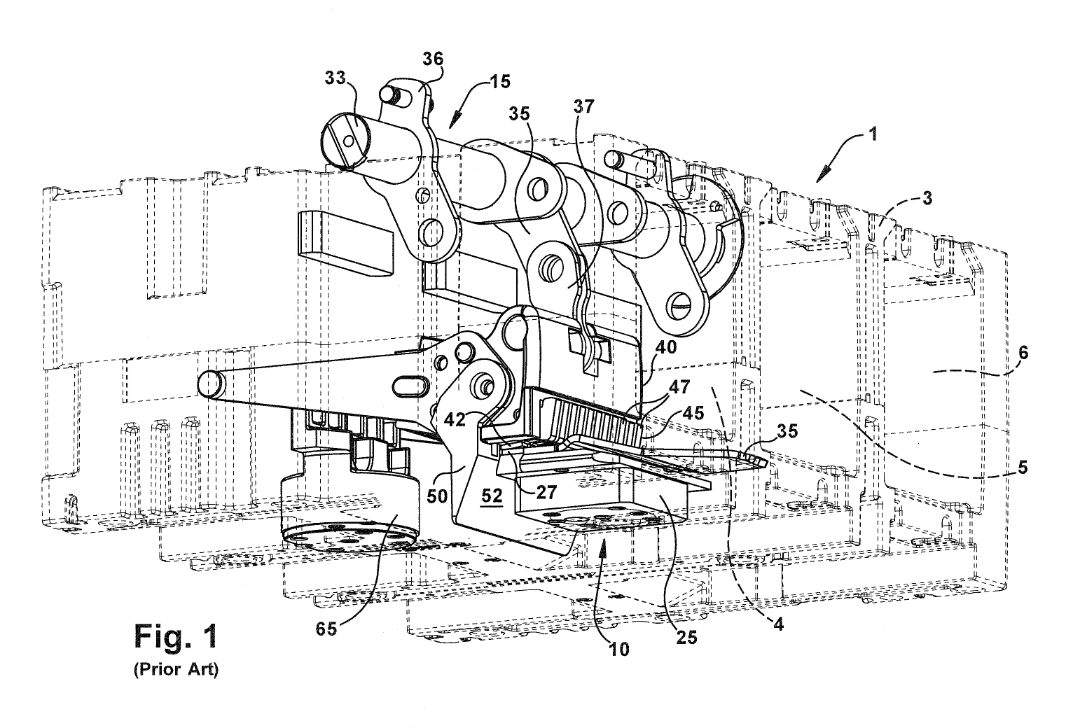

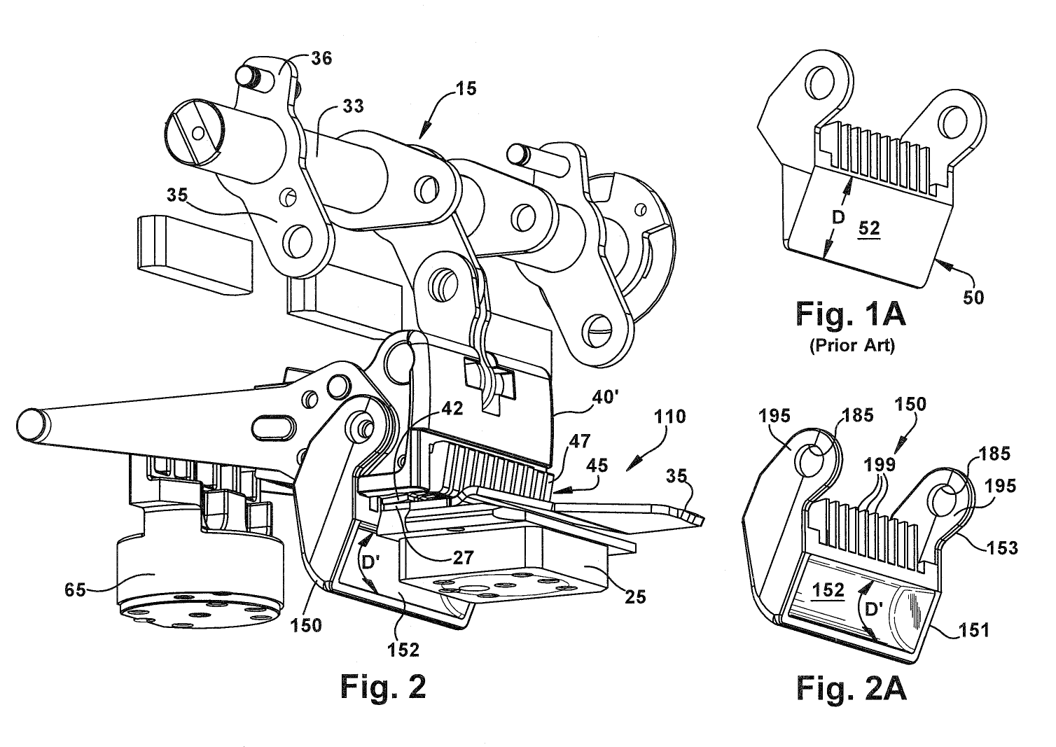

A prior art air circuit breaker 1 is illustrated in FIG. 1. The air circuit breaker includes a housing 3 (shown in dashed line) that forms three pole chambers 4 ,5 ,6, each configured to house a circuit breaker pole 10 (only one pole 10 is shown in solid line in FIG. 1). An operating mechanism 15 is mounted to a front end of the housing 3. The operating mechanism 15 is common to all three circuit breaker poles 10 and is connected to the individual poles by a pole shaft 33 that has a lobe 35 for each pole. The operating mechanism 15 includes a trip unit (not shown) that actuates the operating mechanism to open all the poles of the circuit breaker through rotation of the pole shaft 33 in response to predetermined characteristics of the current flowing through the circuit breaker. In addition, the operating mechanism 15 may be manually actuated by way of a switch lobe portion 36. The switch lobe portion 36 is connected to one or more manually operable switches (not shown) that are accessible outside the housing 3.

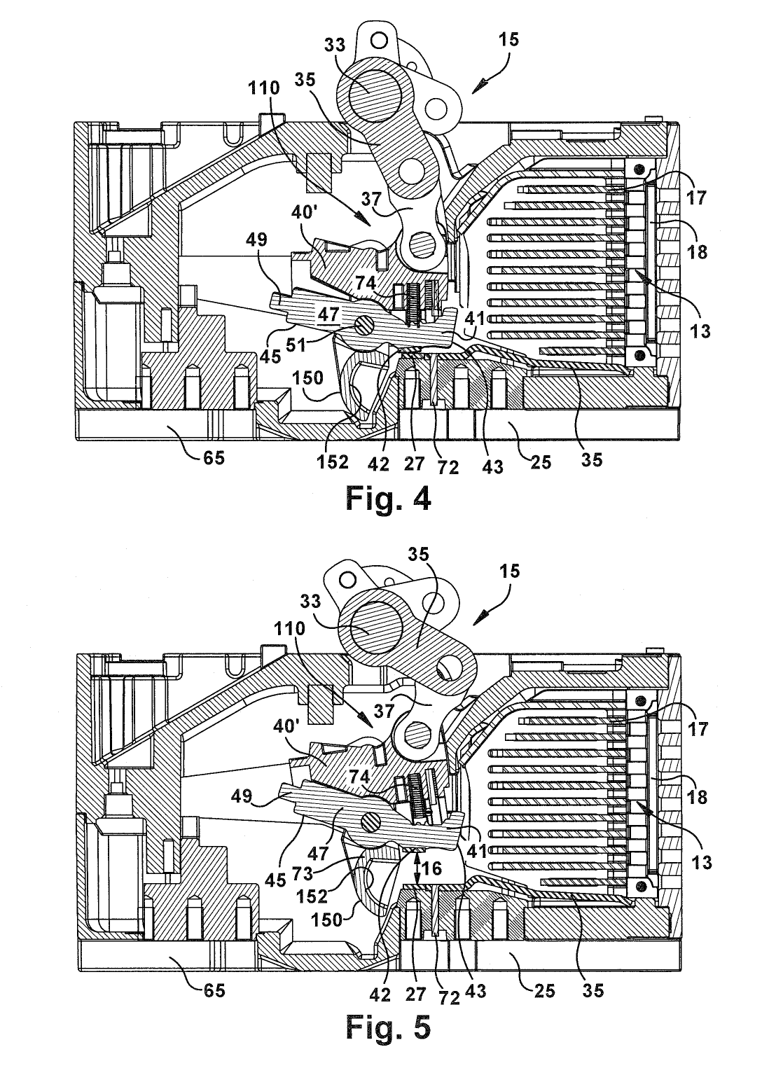

The pole 10, which will be described in more detail below, includes a stationary contact assembly 25 configured to be connected to a line conductor (not shown) that projects rearwardly from the housing 3. The pole 10 also includes a movable contact assembly 45 that is mounted to a contact carriage 40. The contact carriage 40 is operable to carry the moveable contact assembly 45 away from the stationary contact assembly 25. The moveable contact assembly 45 includes a plurality of contact fingers 47 that are pivotally mounted to the contact carriage 40. When the circuit breaker is closed, the moveable contact assembly 45 provides a current path between the stationary contact assembly 25 and a load conductor connector assembly 65 configured to be connected to a load conductor (not shown). The current path includes a stationary contact 27, a moveable contact 42 and a flexible shunt (not shown) connected to bottom end 49 shunt connection feature (FIG. 4) of the contact fingers 47.

A moving seal 50 is also pivotally mounted to the moveable contact carriage 40. The moving seal 50 includes a sealing surface 52 that forms one portion of a sealed arc chamber (not visible in FIG. 1). The moving seal 50 rotates toward the stationary contact assembly 25 and is positioned between the contact carriage 40 and the stationary contact 27 when the contact carriage 40 separates the contacts to pressurize the arc chamber and extinguish the arc. As can be seen best in FIG. 1A, the sealing surface 52 is substantially planar and presents a straight line path for the arc to travel when the contacts are separated. This may cause the moving seal 50 to be susceptible to shorting due to arc creepage as discussed in the background section. This is because the planar sealing surface 52 provides a relatively short straight line path, labeled “D”, between the contact carriage 40 and the stationary contact 27 during contact separation.

FIG. 2 illustrates a circuit breaker pole 110 that includes many of the same components as the pole 10 shown in FIG. 1 and which are assigned the same reference numeral as in FIG. 1. The contact carriage 40′ includes a moving seal 150 that has an arc creepage surface 152. The arc creepage surface 152 is generally concave when compared to the generally planar sealing surface 52 of the moving seal 50 shown in FIG. 1. The arc creepage surface 152 is configured to increase the distance (“D”), relative to the distance presented by the planar sealing surface 52, that the arc must travel along the arc creepage surface 152 before shorting to the contact carriage 40′ while still providing an adequate amount of pressurization of the arc chamber to extinguish the arc. A generally concave arc creepage surface 152 is shown in FIG. 2, however, it will be appreciated that the arc creepage surface could be embodied in any configuration that increases the distance, relative to the straight line distance D presented by the planar sealing surface 52, that the arc must travel along the moving seal 150 before shorting to the contact carriage 40′.

FIG. 2A illustrates the moving seal 150 in more detail. The moving seal 150 includes a sealing portion 151 and an actuation portion 153. The sealing portion includes the arc creepage surface 152 as well as fins 199 that extend behind the arc creepage surface 152. The sealing portion 151 is configured to be positioned between the stationary contact 27 (FIG. 2) and the contact carriage 40′ (FIG. 2) when the contact carriage moves the moveable contact 42 away from the stationary contact 27. Thus, the arc creepage surface 152 defines a portion of the arc chamber when the arc is being extinguished (FIG. 5).

The actuation portion 153 includes spaced legs 195 that have circular recesses 185 that engage the ends of a pivot pin 51 (FIG. 4) to secure the moving seal 150 to the contact carriage 40′ as seen in FIG. 2. The pivot pin 51 is also used to pivotally mount the contact fingers 27 to the contact carriage 40′. Thus, the moving seal 150, by way of the actuation portion, co-acts with the contact carriage 40′ to position the moving seal 150 between the contact carriage and the stationary contact 27 when the contacts separate. When assembled to the pole 110, the fins 199 on the moving seal 150 extend between the contact fingers 47 and align with fins (not shown) arranged between the contact fingers on the contact carriage 40′ to form a seal which prevents the flow of arc gases from passing through the spaces between the contact fingers.

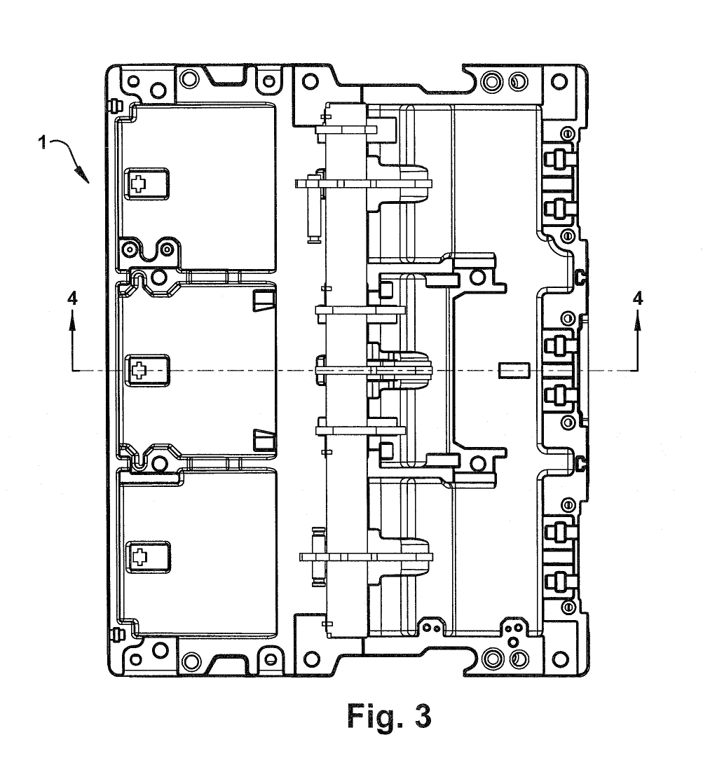

FIGS. 3 is a front view of an air circuit breaker 1 that houses three poles 110 shown in FIG. 2. Section 4-4 is indicated in FIG. 3 and will be used for the cross section views of a pole 110 shown in FIGS. 4-6. The pole 110 can be seen positioned within an arc chamber 13. The arc chamber, which is substantially closed to so that it can be pressurized, includes an outlet 18 through which arc gases may pass. In FIG. 4 the pole 110 is in a closed position so that current may be conducted from the stationary contact assembly 25 to the load connector assembly 65. The contact fingers 47 on the moveable contact assembly 45 are positioned so that the moveable contacts 42 abut the stationary contacts 27. Springs 74 urge the contact fingers 47 into the closed position.

The moveable contacts 42 are fixed to the contact fingers 47 about midway between the pivot pin 51 and a first or free end 41. A shunt connection feature 49 on the contact fingers 47 is adapted to be connected to a flexible shunt (not shown) that connects the contact fingers 47 to the load conductor connector assembly 65. Adjacent to the free end 41 of the contact fingers is an arc toe 43 that forms a moveable arcing contact which cooperates with an arc runner 35 to guide the arc from into an arc chute 17 in the arc chamber 13 to be extinguished. The moving seal 150 is also pivotally mounted to the pivot pin 51 on the contact carriage 40′. In the closed position, the moving seal 150 is positioned down below the stationary contact 27.

FIG. 5 illustrates the circuit breaker pole 110 as it begins to open in response to rotation of the shaft 33 that acts upon the linkage between the lobe 35 and link 37 to rotate the contact carriage 40′. An arc chamber inlet 16 is created by the movement of the contact carriage 40′. The contact carriage 40′ begins to rotate counter clockwise and the springs 74 rock the contact fingers 47 clockwise so that arc toe 43 contacts the arc runner while the moveable contacts 42 are separated from the stationary contact 27. Continued rotation of the contact carriage causes the moving seal 150 rotate up toward the stationary contacts 27 to the position shown in FIG. 5. The moving seal 150 is positioned to seal between the contact fingers 47 and to place the arc creepage surface 152 just below the stationary contact 27 to close off the arc chamber inlet 16 so that the arc can be extinguished.

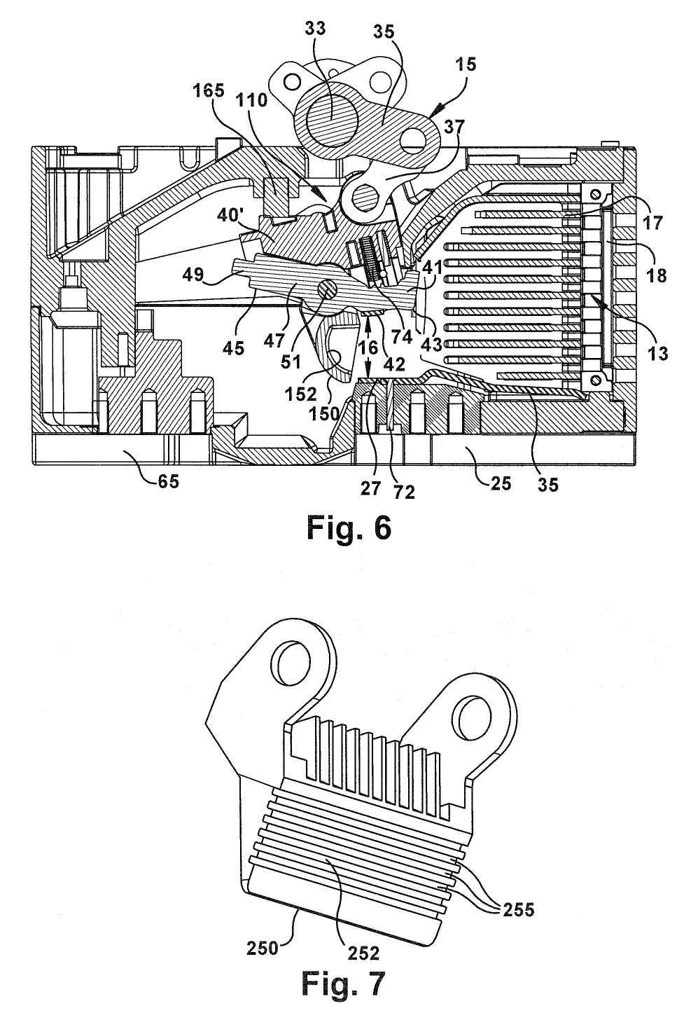

Any arc that remains between the contacts 42, 27 will have to travel the entire distance D′ (FIG. 2A) presented by the concave arc creepage surface 152 before it can short to the contact fingers 47. FIG. 6 shows the pole 110 in the open position. The contact carriage 40′ has rotated counterclockwise until it rests against a stop 165 in the housing. The moveable contacts 42 are separated from the stationary contact 27 and the arc toe is also separated from the arc runner 35.

FIG. 7 illustrates an alternative embodiment of a moving seal 250 with an arc creepage surface 252 that includes a plurality of parallel concave grooves 255. Like the concave arc creepage surface 152 of FIGS. 2-6, the grooved arc creepage surface 252 increases the distance, relative to the distance D presented by the planar sealing surface 52 (FIG. 1A), that the arc must travel along the moving seal 250 before shorting to the contact fingers 47 (FIGS. 4-6). While two alternative embodiments of an arc creepage surface are described herein, it will be appreciated that the arc creepage surface could be embodied in any configuration that increases the distance that the arc must travel along the moving seal before shorting to the contact fingers.

To the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A moving seal comprising:
a sealing portion having an arc creepage surface that is positioned between first and second circuit breaker contacts when the sealing portion is fit into an arc chamber enclosing the first and second circuit breaker contacts;
the arc creepage surface having a surface contour that increases a length of an arc travel path between the second circuit breaker contact and a contact carriage that carries the first circuit breaker contact, relative to a straight line distance between the second circuit breaker contact and the contact carriage.

2. The moving seal of claim 1 further comprising:
an actuation portion configured to co-act with the contact carriage, where the contact carriage is operable to separate first and second circuit breaker contacts, further where the arc chamber is substantially closed and where an inlet is formed between the first and second circuit breaker contacts when the contact carriage carries the first circuit breaker contact away from the second circuit breaker contact;
and where the sealing portion is configured to fit within the inlet to seal the inlet such that the arc creepage surface defines a portion of the arc chamber; and
where the actuation portion is operable to selectively position the sealing portion in the inlet in response to the contact carriage carrying the first circuit breaker contact away from the second circuit breaker contact.

3. The moving seal of claim 1 where the arc creepage surface has a substantially concave surface contour.

4. The moving seal of claim 1 where the arc creepage surface comprises a single concave groove.

5. The moving seal of claim 1 where the arc creepage surface comprises a plurality of parallel concave grooves.

6. A circuit breaker comprising:
a substantially closed arc chamber enclosing a pair of separable contact assemblies, the arc chamber including an inlet that is formed between the pair of separable contact assemblies when the separable contact assemblies are separated;
a moving seal configured to be fit within the inlet to close the inlet and define a portion of the arc chamber; and
where the moving seal comprises an arc creepage surface that is positioned between the pair of separable contact assemblies when the moving seal is fit into the inlet; the arc creepage surface having a surface contour that increases a length of an arc travel path between the separable contact assemblies, relative to a straight line distance between the separable contact assemblies.

7. The circuit breaker of claim 6 where the arc creepage surface has a substantially concave surface contour.

8. The circuit breaker of claim 6 where the arc creepage surface comprises a single concave groove.

9. The circuit breaker of claim 6 where the arc creepage surface comprises a plurality of parallel concave grooves.

10. A circuit breaker apparatus comprising means for providing an arc creepage surface that is positioned between a pair of separable contact assemblies when the contacts are separated; the arc creepage surface having a surface contour that increases a length of an arc travel path between the separable contact assemblies, relative to a straight line distance between the separable contact assemblies.

11. The apparatus of claim 10 where the arc creepage surface has a substantially concave surface contour.

12. The apparatus of claim 10 where the arc creepage surface comprises a single concave groove.

13. The apparatus of claim 10 where the arc creepage surface comprises a plurality of parallel concave grooves.

14. The apparatus of claim 10 where the means for providing an arc creepage surface comprises a moving seal.
